(19) United States
(12) Patent Application Publication
(10) Pub. No.: US 2011/0080047 A1
(43) Pub. Date: Apr. 7, 2011

(54) SOLAR POWER SUPPLY SYSTEM SUPPORTING AC/DC POWER CONVERSION LOADS

(76) Inventor: Wen-Xin LI, Hsinchu City (TW)

(21) Appl. No.: 12/571,452

(22) Filed: Oct. 1, 2009

(51) Int. Cl. H02J 1/10

(52) U.S. Cl. 307/44

(57) ABSTRACT

A solar power supply system includes a power supply unit, a rectification unit, a solar power supply unit and an AC/DC power conversion load. The power supply unit may be an AC power derived from a household electrical source and then rectified to a second DC power through the rectification unit. The solar power supply unit has at least one solar panel connected in series or parallel to provide a first DC power. The AC/DC power conversion load receives the second DC power from the power supply unit and the first DC power from the solar power supply unit, and supplies the power to an appliance.

### FIELD OF THE INVENTION

The present invention relates to a solar power supply system and particularly to a solar power supply system that supports AC/DC power conversion loads.

### BACKGROUND OF THE INVENTION

In the time when worldwide economy is devastated by depletable energy resources, it is also a high time to explore renewable energy resources. Energy contained in solar radiation is huge. It is estimated that 34% of them is reflected into outer space, 19% is absorbed by atmosphere and only 47% is absorbed by earth surface. In one year the energy transmitted from sun to earth is about 1.3×10²⁴ calories. It is about 26000 times of total energy consumption of all human being in one year. Hence the solar energy will become the permanent energy source if it is efficiently utilized by human being.

However, solar energy utilization is still not wide spread to date since the solar power equipment is still expensive. Another hindrance is that the present solar power conversion efficiency of those equipments is in the range about 10%-20%. Since industrial revolution large scale electric power generation mainly adopt thermal power, hydraulic power and nuclear power at a lower cost to supply industrial use worldwide. Take into account of production cost, solar power industry still is not well developed and the equipments are still too expensive. As a result, it was overlooked for a prolonged period of time. But in recent years the costs of raw materials for thermal power generation soar greatly. Moreover, extensive studies show that the conventional power generation, such as thermal power, hydraulic power and nuclear power generation create huge impact and damages to the environment and entire eco-system on earth. That results in abnormal climates. Hence awareness of earth protection grows significantly in recent years. This also dawns many people that solar power is the only permanent natural energy resource of mankind.

However, adoption to solar power entirely still is not feasible at present. As deploying solar power generation has to install new power transmission lines, and thus results in higher expense than the conventional power generation systems. Moreover, due to system structure constraints and deficiency, power actually and finally delivered to the load in the conventional solar power generation system usually drops from 100% to 50˜60% after conversion or storage. Hence how to improve the system structure of the solar power generation system to quickly deploy the solar power energy to the existing power systems at a lower cost to save energy and reduce power consumption is an urgent issue remained to be resolved.

### SUMMARY OF THE INVENTION

Therefore the primary object of the present invention is to provide a solar power supply system to support AC/DC power conversion load.

To achieve the foregoing object the present invention includes a power supply unit, a rectification unit, a solar power supply unit and an AC/DC power conversion load. The power supply unit can be an AC power derived from a household electrical source. The AC power is rectified to generate a second DC power through the rectification unit to supply to the AC/DC power conversion load. The solar power supply unit is connected between the rectification unit and the AC/DC power conversion load, and has at least one solar power panel coupled in series or parallel to provide a first DC power. The AC/DC power conversion load receives the second DC power from the rectification unit and the first DC power from the solar power supply unit when an appliance regarded as the AC/DC power conversion load is in use.

Therefore, the solar power supply system of the present invention can be used on household electrical appliances such as regular lighting equipment (e.g. energy-saving lamp sets and lighting bulbs), frequency conversion air conditioners and computer power supply and the like that consume electric power. The power ratio required by the AC/DC power conversion load can be adjusted automatically or fully to supply to the appliance according to maximum power generated by the solar power supply unit so as to reduce power consumption and save energy. For instance, install the solar power supply unit on a sunshine abundant location. During peak power utilization period, the solar power supply unit can generate adequate electric power to supply to the AC/DC power conversion load, and the power of the power supply unit is not consumed. In the event that the power provided by the solar power supply unit cannot fully meet requirement, the power supply unit supplements the deficient power.

The foregoing, as well as additional objects, features and advantages of the invention will be more readily apparent from the following detailed description, which proceeds with reference to the accompanying embodiment and drawings. The embodiment serves only for illustrative purpose and is not the limitation of the invention.

### BRIEF DESCRIPTION OF THE DRAWINGS

FIG. 1 is a schematic view of the system structure of the present invention.

FIG. 2 is a schematic view of current waveforms passing through the rectification unit according to the present invention.

FIG. 3 is a schematic view of power supply provided by the solar power supply unit and the power supply unit according to the present invention.

FIG. 4 is a schematic view of utilizing power provided by the solar power supply unit and power supply unit according to the present invention

### DETAILED DESCRIPTION OF THE PREFERRED EMBODIMENT

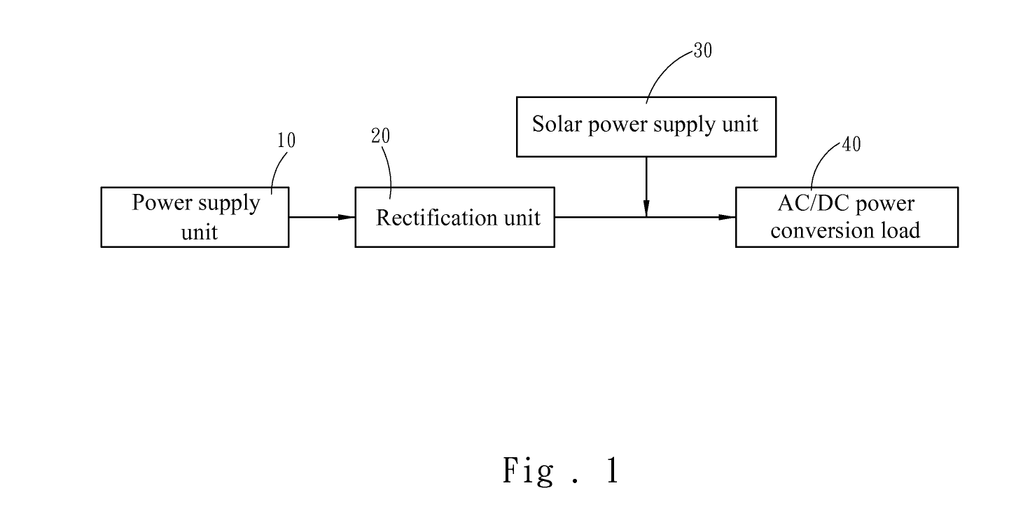

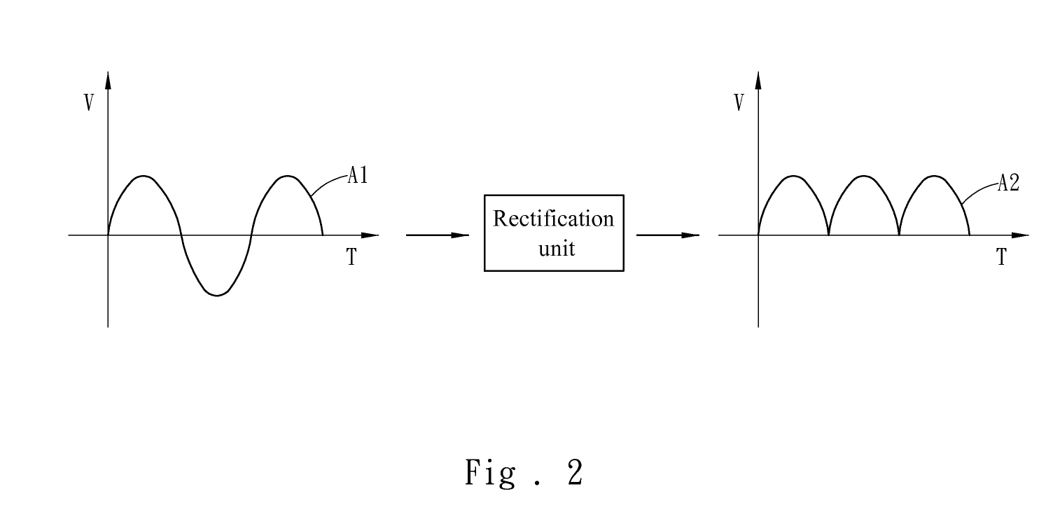

Please refer to FIG. 1, the solar power supply system to support AC/DC power conversion loads according to the present invention includes a power supply unit 10, a rectification unit 20, a solar power supply unit 30 and an AC/DC power conversion load 40. The power supply unit 10 can be an AC power A1 derived from a household electrical source (such as AC100V) (also refer to FIG. 2) which is rectified by the rectification unit 20 to generate a second DC power A2. The AC/DC power conversion load 40 is connected to the rectification unit 20, and may be an energy-saving lamp set, an electronic power-saving lighting bulb, a frequency conversion air conditioner or a computer power supply and the like that consumes electric power. The solar power supply unit 30 is connected between the rectification unit 20 and the AC/DC power conversion load 40, and has at least one solar power panel (not shown in the drawings) coupled in series or parallel to provide a first DC power A3.

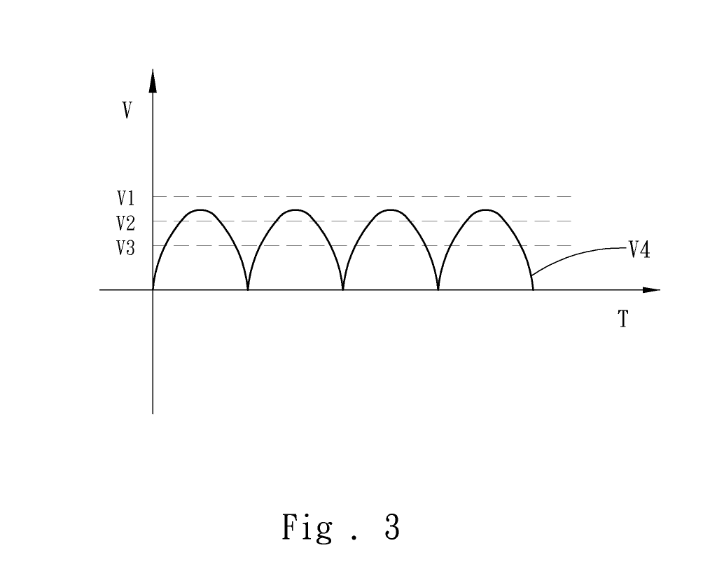

Please refer to FIG. 3 for power supply provided by the solar power supply unit 30 and the power supply unit 10 according to the present invention. The horizontal axis represents time T, and the vertical axis represents currents V. V1, V2 and V3 indicate respectively the solar power supply unit 30 providing 100%, 70% and 30% of solar power supply required by the AC/DC power conversion load 40. The sinusoidal wave V4 represents power supply provided by the power supply unit 10. The feature of the present invention relies on that the first DC power A3 and the second DC power A2 supplied to the AC/DC power conversion load 40 at the same time (one is from the household electrical source, namely the power supply unit 10, and the other is from the solar power supply unit 30). Based on the DC power characteristics, when the solar power supply unit 30 provides the power V1 greater than the power V4 provided by the power supply unit 10, the AC/DC power conversion load 40 fully receives the power of the solar power supply unit 30. On the other hand, when the solar power supply unit 30 provides the power V2 or V3 less than the power V4 provided by the power supply unit 10, the power supply unit 10 shares a portion of power and sent to the AC/DC power conversion load 40 to meet requirement thereof.

For instance, in the event that the solar power supply unit 30 can provide adequate power needed by the AC/DC power conversion load 40 (such as 100% of power), the AC/DC power conversion load 40 fully receives (100%) the power provided by the solar power supply unit 10, and power consumption of the power supply unit 10 is 0%. In the event that solar power supply unit 30 can only provide 50% or 30% of the power needed by the AC/DC power conversion load 40, the AC/DC power conversion load 40 consumes other 50% or 70% of power provided by the power supply unit 10. In other words, the amount of power generated by the solar power supply unit 30 determines the amount of power shared by the power supply unit 10. Thus power reduction and energy saving effect can be accomplished.

It is to be noted that the solar power supply unit 30 generates power to be directly used by the AC/DC power conversion load 40. When the AC/DC power conversion load 40 receives the first DC power A3 generated by the solar power supply unit 30, power loss is lower than the conventional solar power generation system.

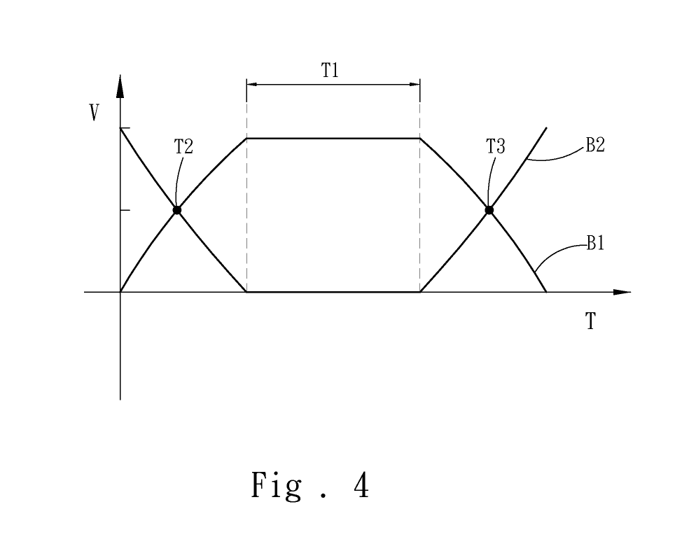

The structure thus formed can be used on household electrical appliances such as regular lighting equipment (e.g. energy-saving lamp sets or lighting bulbs), frequency conversion air conditioners and computer power supply and the like that consume electric power. Automatic power regulation can be achieved according the load to reduce power consumption and save energy. Refer to FIG. 4 for utilizing power provided by the solar power supply unit 30 and the power supply unit 10 according to the present invention. The horizontal axis represents time T, the vertical axis represents current V, line B1 represents the power supplied by the solar power supply unit 30, and line B2 represents the power supplied by the power supply unit 10. For instance, install the solar power supply unit 30 on a sunshine abundant location. During peak power utilization period T1 and the solar power supply unit 30 can generate 100% of electric power needed by the AC/DC power conversion load 40, the power of the electric power supply unit 10 represented by line B2 in duration T1 is not consumed. Even in off-peak power utilization periods T2 and T3, and the solar power supply unit 30 provides the power lower than the power supply unit 10, the power supply unit 10 shares only the deficient portion of the power (such as 50%) consumed by the AC/DC power conversion load 40.

While the preferred embodiment of the invention have been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A solar power supply system supporting AC/DC conversion load, comprising:
a power supply unit connecting to a rectification unit;
an AC/DC power conversion load connecting to the rectification unit; and
a solar power supply unit connected between the rectification unit and the AC/DC power conversion load to provide a first DC power.

2. The solar power supply system of claim 1, wherein the power supply unit generates a second DC power through the rectification unit.

3. The solar power supply system of claim 1, wherein the solar power supply unit is connected in series with at least one solar panel.

4. The solar power supply system of claim 1, wherein the solar power supply unit is connected in parallel with at least one solar panel.

5. The solar power supply system of claim 1, wherein the AC/DC power conversion load receives the second DC power from the power supply unit and the first DC power from the solar power supply unit.
